(19) United States
(12) Patent Application Publication
(10) Pub. No.: US 2024/0348561 A1
(43) Pub. Date: Oct. 17, 2024

(54) PACKET PROCESSING WITH HARDWARE OFFLOAD UNITS

(71) Applicant: VMware LLC, Palo Alto, CA (US)

(72) Inventors: Yong Wang, Sunnyvale, CA (US); Boon S. Ang, Saratoga, CA (US); Guolin Yang, San Jose, CA (US); Wenyi Jiang, Fremont, CA (US)

(21) Appl. No.: 18/751,765

(22) Filed: Jun. 24, 2024

Related U.S. Application Data
(63) Continuation of application No. 17/091,663, filed on Nov. 6, 2020, now Pat. No. 12,021,759.
(60) Provisional application No. 63/084,425, filed on Sep. 28, 2020.

(51) Int. Cl. H04L 49/1546

(52) U.S. Cl. CPC H04L 49/1546

(57) ABSTRACT

Some embodiments of the invention provide a method for configuring multiple hardware offload units of a host computer to perform operations on packets associated with machines (e.g., virtual machines or containers) executing on the host computer and to pass the packets between each other efficiently. For instance, in some embodiments, the method configures a program executing on the host computer to identify a first hardware offload unit that has to perform a first operation on a packet associated with a particular machine and to provide the packet to the first hardware offload unit. The packet in some embodiments is a packet that the particular machine has sent to a destination machine on the network, or is a packet received from a source machine through a network and destined to the particular machine.

### CROSS-REFERENCE TO RELATED APPLICATION

This application is a continuation of U.S. patent application Ser. No. 17/091,663 filed on Nov. 6, 2020, which claims priority to U.S. Provisional Patent Application No. 63/084,425 filed Sep. 28, 2020, the disclosure of both of which are incorporated in their entirety by reference herein.

### BACKGROUND

In recent years, there has been an increase in the use of hardware offload units to assist functions performed by programs executing on host computers. Examples of such hardware offload units include FGPAs, GPUs, smartNICs, etc. Such hardware offload units have improved performance and efficiency requirements of the host computers, and are driving towards specialized accelerators in datacenters. However, there has been a lack of solutions for performing a chain of offload operations with several different hardware offload units.

### SUMMARY

Some embodiments of the invention provide a method for configuring multiple hardware offload units of a host computer to perform operations on packets associated with machines (e.g., virtual machines or containers) executing on the host computer and to pass the packets between each other efficiently. For instance, in some embodiments, the method configures a program executing on the host computer to identify a first hardware offload unit that has to perform a first operation on a packet associated with a particular machine and to provide the packet to the first hardware offload unit. The packet in some embodiments is a packet that the particular machine has sent to a destination machine on the network, or is a packet received from a source machine through a network and destined to the particular machine.

In addition to configuring the program to provide the packet to the first hardware offload unit, the method also configures the first hardware offload unit to perform the first operation on the packet, to identify a second hardware offload unit that has to perform a second operation on the packet, and to provide the packet to the second hardware offload unit. The method further configures the second hardware offload unit to perform the second operation on the packet.

In some embodiments, the method configures the first hardware offload unit to provide the packet to the second hardware offload unit by writing to a register of the second hardware offload unit. In other embodiments, the process configures a hardware offload unit to provide the packet to another hardware offload unit by writing to a memory of the host computer, and providing a notification to the second hardware offload unit that it needs to retrieve the packet from the host computer's memory.

In some cases, the method of some embodiments configures the second hardware offload unit to provide the packet back to the program after performing the second operation on the packet, while in other cases it configures (1) the second hardware offload unit to provide the packet to a third hardware offload unit after performing the second operation on the packet, and (2) configures the third hardware offload unit to perform a third operation on the packet.

The program that identifies the first hardware offload unit in some embodiments is an operating system of the host computer. In other embodiments, this program is a hypervisor over which virtual machines execute on the host computer. In some embodiment, the program performs an operation on the packet before providing the packet to the first hardware offload unit to perform a first operation and/or performs an operation on the packet after the second hardware offload unit and/or another hardware offload unit has performed an operation on the packet.

The operations performed by the program and the hardware offload units in some embodiments are packet forwarding operations and/or middlebox service operations. Also, in some embodiments, the program and/or hardware offload units use a set of attributes of the packet (e.g., header values of the packet) to identify the packet forwarding and/or middlebox service operation to perform on the packet, and/or to identify the processing program or hardware offload unit that has to process the packet next.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, the Detailed Description, the Drawings and the Claims is needed. Moreover, the claimed subject matters are not to be limited by the illustrative details in the Summary, the Detailed Description and the Drawings.

### BRIEF DESCRIPTION OF FIGURES

The novel features of the invention are set forth in the appended claims. However, for purposes of explanation, several embodiments of the invention are set forth in the following figures.

FIG. 1 conceptually illustrates the operation of a host computer and its hardware offload units when these components are configured according to the method of some embodiments.

FIGS. 2 and 3 conceptually illustrate processes that a packet-processor and a hardware offload unit perform in some embodiments to process packets.

FIG. 4 conceptually illustrates examples of match-action records that the packet processor uses in some embodiments to identify a sequence of operations that have to be performed for a particular flow identifier.

FIG. 5 conceptually illustrates an example of a packet's flow identifier being associated with multiple match-action records, with each record specifying a different operation to perform on the packets associated with the particular flow identifier.

FIG. 6 conceptually illustrates an example of a packet being sequentially processed by the packet processor and the hardware offload units of the host computer.

FIG. 7 conceptually illustrates an example of a CPU-centric model that performs a chain of packet processing operations on a packet.

FIG. 8 conceptually illustrates a network control system that configures multiple hardware offload units of one or more host computers to perform operations on packets associated with machines executing on these computers and to pass the packets between each other efficiently.

FIG. 9 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a method for configuring multiple hardware offload units of a host computer to perform operations on packets associated with machines (e.g., virtual machines or containers) executing on the host computer and to pass the packets between each other efficiently. For instance, in some embodiments, the method configures a program (e.g., operating system, hypervisor, etc.) executing on the host computer to identify a first hardware offload unit that has to perform a first operation on a packet associated with a particular machine and to provide the packet to the first hardware offload unit. The method also configures the first hardware offload unit to perform the first operation on the packet, to identify a second hardware offload unit that has to perform a second operation on the packet, and to provide the packet to the second hardware offload unit.

The method further configures the second hardware offload unit to perform the second operation on the packet, and then to provide the packet back to the program, or to provide the packet to a third hardware offload unit, which it configures to perform a third operation on the packet. In some embodiments, the method configures each hardware offload unit to provide the packet after the unit's processing of the packet to another hardware offload unit, or to return the packet back to the program in case the hardware offload unit is the last unit in a chain of units that processes the packet. Also, in some embodiments, the method configures the program to perform operations on the packet before providing the packet to a hardware offload unit, or after receiving the packet from a hardware offload unit.

The operations performed by the program and the hardware offload units in some embodiments are packet forwarding operations and/or middlebox service operations. Also, in some embodiments, the program and/or hardware offload units use a set of attributes of the packet (e.g., header values of the packet) to identify the packet forwarding and/or middlebox service operation to perform on the packet, and/or to identify the processing program or hardware offload unit that has to process the packet next.

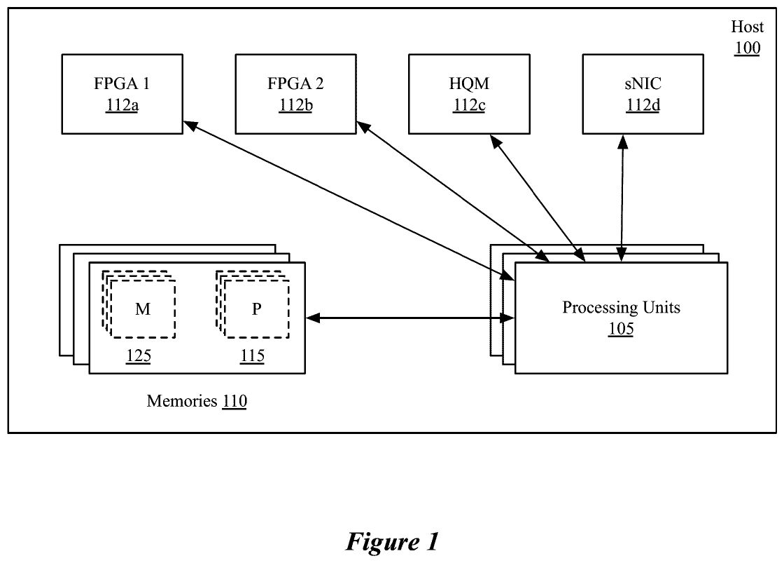

FIG. 1 illustrates the operation of a host computer 100 and its hardware offload units when these components are configured according to the method of some embodiments. In this example, the host computer has a set of processing units 105 (e.g., processor cores), a set of memories 110 (e.g., volatile and non-volatile memories), and four hardware offload units 112a-d. The hardware offload units include two field programmable gate arrays 112a and 112b, a hardware queue manager 112c and a smart network interface card (NIC) 112d.

The processing units execute one or more software processes 115 and machines 125 that are stored in one or more memories 110. The machines 125 are endpoint machines, such as virtual machines (VMs) or containers in some embodiments. These machines send and receive packets through the physical network interface card (PNIC) of the host computer. In some embodiments, the PNIC of the host computer is a smart NIC 112d, which is one of the hardware offload units of the host computer. The software processes 115 are packet processors that perform forwarding operations (L2 switching and L3 routing operations) and/or middlebox service operations (e.g., firewall, load balancing, etc.) on the packets.

In some embodiments, one or more of the software processes 115 are configured to offload one or more operations from the host computer's processing units 105 to the hardware offload units 112a-d. Moreover, in some embodiments, each particular hardware offload units can be configured to identify another hardware offload unit that has to perform a subsequent operation on the packet processed by the particular hardware offload unit, and to notify this other hardware offload unit that it needs to process the packet. This is in contrast to a technique that would have each hardware offload unit return the packet to the host computer, in order for a packet processor 115 on the host computer to identify a subsequent hardware offload unit that needs to process the packet next.

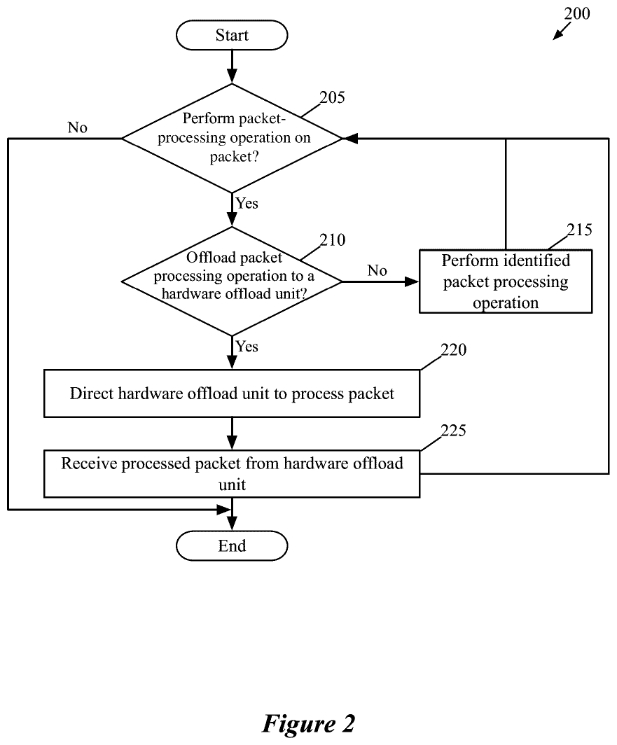

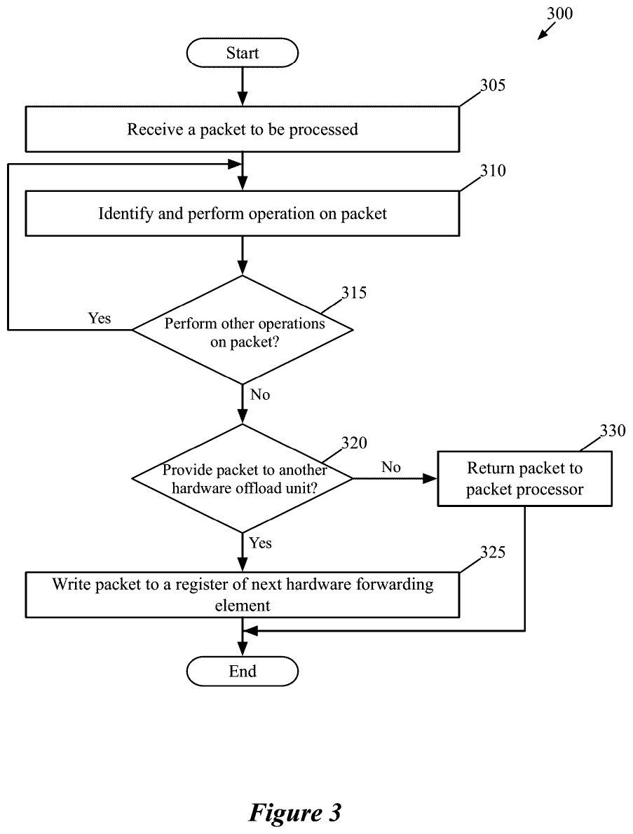

FIGS. 2 and 3 illustrate processes 200 and 300 that a packet-processor 115 and a hardware offload unit perform in some embodiments to process packets. The process 200 starts each time the packet processor 115 identifies a packet that it needs to process as the packet traverses along an ingress path to, or an egress path from, a machine 125 executing on the packet processor's host computer 100.

As shown, the process 200 initially determines (at 205) whether any packet-processing operation (e.g., forwarding or middlebox operation) has to be performed on the packet. If so, the process determines (at 210) whether the packet processing operation has to be performed by the process 200 or another software packet processor executing on the host computer, or whether the next packet processing operation should be offloaded to a hardware offload unit. In some embodiments, the process 200 uses a set of attributes of the packet (e.g., header values of the packet) to identify the packet forwarding and/or middlebox service operation to perform on the packet, and/or to determine whether it or a hardware offload unit has to process the packet.

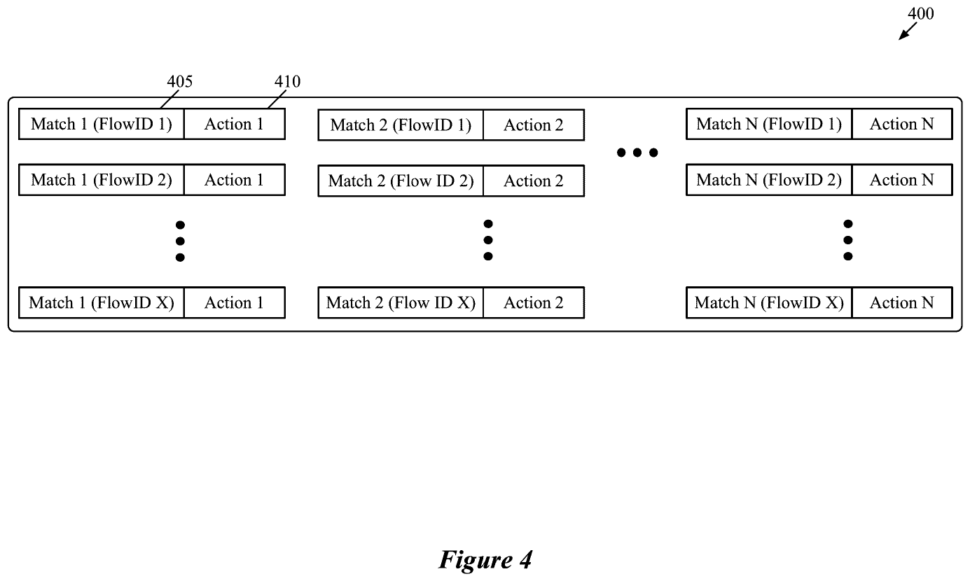

FIG. 4 illustrates examples of match-action records 400 that the packet processor 115 uses in some embodiments to identify a sequence of operations that have to be performed for a particular flow identifier 405. Each record's flow identifier has a set of packet attributes (e.g., header values) that match one or more possible packet flows. Each record also specifies one or more operations 410 and an identifier 405 for a software process or a hardware offload unit for performing the operation.

When the process 200 determines (at 210) that it, or another software packet processor executing on the host computer, has to process the packet, it transitions to 215. At 215, the process 200 or the other software packet processor performs the identified packet processing operation (e.g., a forwarding or middlebox service operation), and then returns to 205. On the other hand, when the process determines (at 210) that it should offload the processing of the packet to a particular hardware offload unit, it directs (at 220) the particular hardware offload unit to process the packet, and then transitions to 225 to await this particular hardware offload unit or another hardware offload unit to return the processed packet. In some embodiments, the process 200 directs the hardware offload unit to process the packet by writing the packet to a register of the particular hardware offload unit. In other embodiments, the process 200 writes the packet to a location in the host-computer memory 110 and notifies the particular hardware offload unit that it has to retrieve the packet from the host-computer memory.

The process waits at 225 until it receives the packet from the particular hardware offload unit that it called at 220, or from another hardware offload unit that was called by this particular hardware offload unit or other hardware offload units in performing a chain of operations that started when the process called the particular hardware offload unit at 220. After receiving the packet, the process transitions from 225 back to 205 to determine whether a software packet processor or a hardware offload unit has to perform additional operations on the packet. If so, the process 200 transitions to 210, which was described above. Otherwise, the process 200 ends.

FIG. 3 illustrates the process 300 performed by a hardware offload unit 112 after receiving a packet from a packet processor 115 or another hardware offload unit 112. As shown, the process 300 starts when the hardware offload unit receives (at 305) a packet to process. At 310, the process then identifies and performs an operation on the packet. In some embodiments, the process performs (at 310) a match-action operation, which matches the received packet's attributes (e.g., header values) with a match record, and then performs the operation specified by the action record associated with this match record.

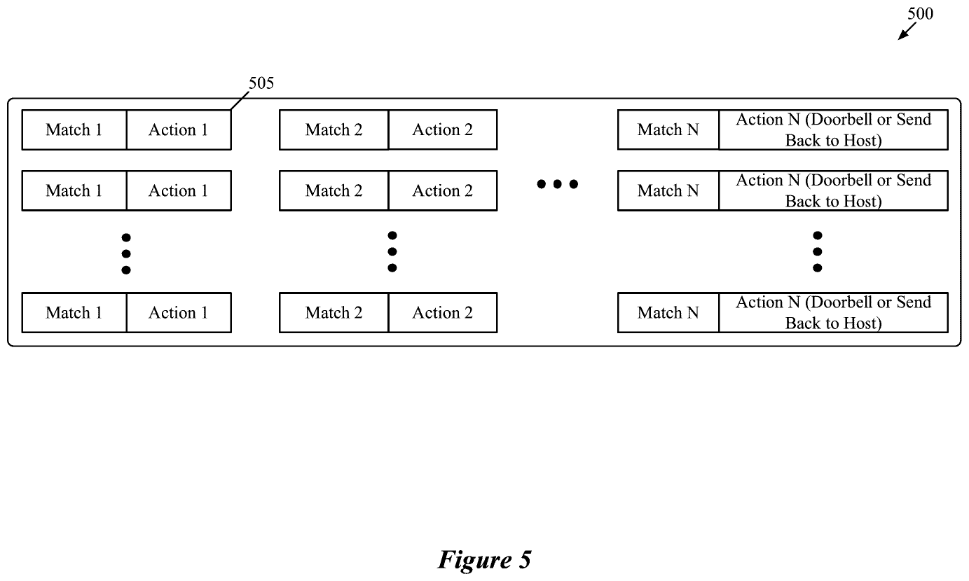

FIG. 5 conceptually illustrates an example of a packet's flow identifier 500 being associated with multiple match-action records 505, with each record specifying a different operation to perform on the packets associated with the particular flow identifier 500. To process a packet for one or more operations, a hardware offload unit might have to perform multiple sub-operations, with each sub-operation specified by a match-action record that is processed by a different processing stage (e.g., match-action stage) in the packet-processing pipeline of the hardware offload unit.

After performing (at 310) an operation on the packet, the process 300 determines (at 315) whether it has to perform any other operations on the packet. In some embodiments, this determination involves determining whether the packet's flow identifier matches the match records of any other match-action records of any remaining packet-processing pipeline stages of the hardware offload unit that do not require providing the packet to another hardware offload unit or back to the packet processor 115.

When the process 300 determines (at 315) that it has to perform another operation on the packet, it transitions back to 310 to perform the identified operation (e.g., to perform the operation associated with the action record associated with the next match record with which packet has been matched). Otherwise, when the process determines (at 315) that the hardware offload unit does not need to perform any other operations on the packet, it determines (at 320) whether it has to provide the packet to another hardware offload unit.

This determination in some embodiment entails the process matching the packet's flow identifier with a match record that has an associated action record, which specifies the forwarding of the packet to another hardware offload unit. In some embodiments, the action record specifies a particular port of the current hardware forwarding element that is associated with the next hardware forwarding element.

When the current hardware forwarding element determines (at 320) that it has to provide the packet to another hardware offload unit, the current hardware forwarding element in some embodiments writes (at 325) the packet to a register of the next hardware forwarding element. In other embodiments, the current hardware forwarding element (at 325) writes the packet back to a memory location of the host computer, while writing a notification in the register of the next hardware forwarding element to notify it that it needs to retrieve the packet from the stored memory location on the host computer. After 325, the process 300 ends. When the process 300 determines (at 320) that it does not need to provide the packet to another hardware offload unit, it returns (at 330) the packet to the packet processor 115, and then ends.

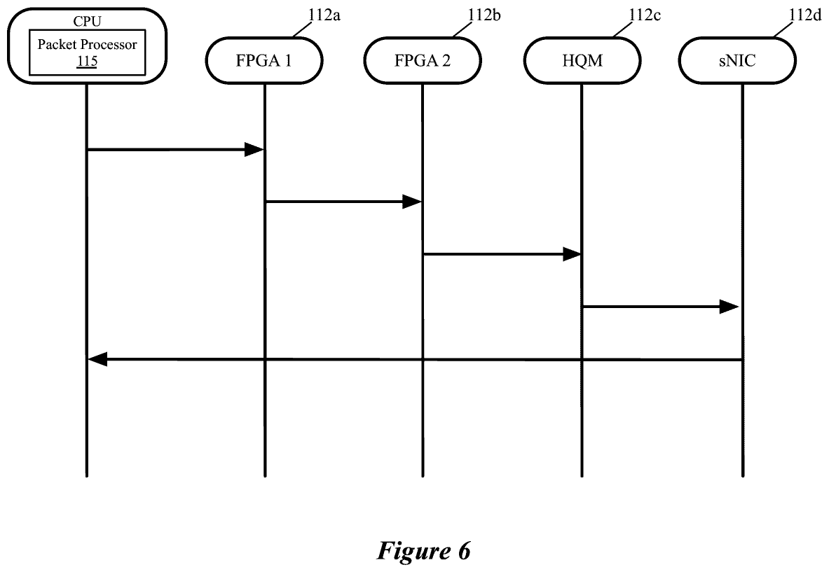

FIG. 6 illustrates an example of a packet being sequentially processed by the packet processor 115 and the hardware offload units 112a-d of the host computer 100. The approach illustrated in this example leverages the capability of each hardware offload unit to support direct memory access (DMA) with a shared address space. Hence, as shown, the packet processor 115 (which is being executed by one or more processor units 105) provides a pointer to the initial packet to the first hardware offload unit in a chain of hardware offload units that performs a chain of packet-processing operations on the packet.

Upon receiving the pointer, the first hardware offload unit 112a can process its match/actions stages without involvement of the processing units of the host computer. The first hardware offload unit can then pass the packet to the next hardware offload unit 112b, which then performs its packet-processing operations before passing the packet to the next hardware offload unit. This process continues until all the hardware offload units have processed the packet. The communication between the hardware offload units in some embodiments is done through a doorbell mechanism where the current hardware offload unit provides a notification (i.e., pushes a “doorbell”) to trigger the next hardware offload unit to read from the memory address (specified by a pointer) for its own processing. In other embodiments, this communication is achieved using a message queue where the action from the current hardware offload unit sends a request to the next hardware offload unit's request queue with enough information to trigger the next hardware offload unit to start its own pipeline.

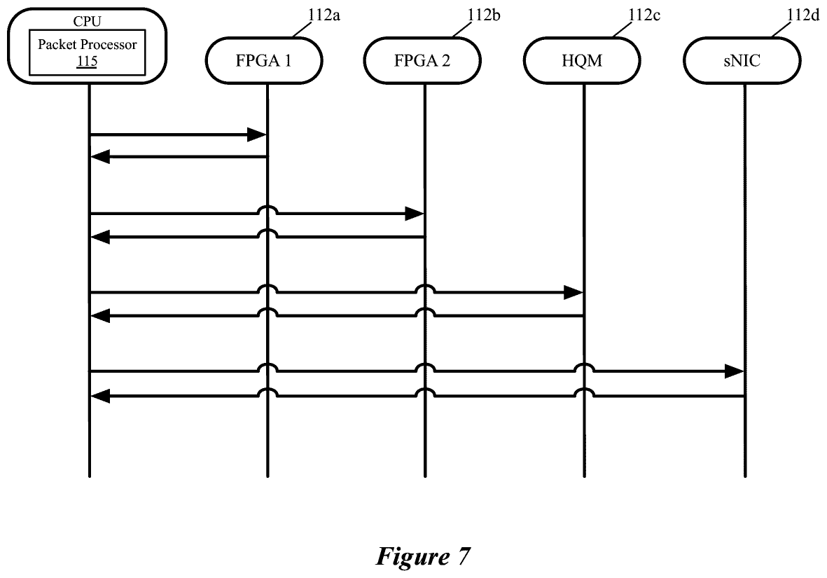

The approach illustrated in FIG. 6 is a much better approach to CPU-centric model illustrated in FIG. 7. The approach in FIG. 7 requires the host computer's processing units to assist the hardware offload units to identify the next hardware offload units in a chain of hardware offload units that performs a chain of packet processing operations on a packet. In other words, to leverage the offloading capabilities of the hardware offload unit, the host computer's processing units need to be involved for every packet.

For example, when a packet is received by the host operating system, it will process it based on the configuration pipeline. At certain stage of this processing, say cryptography, or HQM, the host OS needs to send the packet back to a hardware offload unit and then receive it back from this unit to continue its processing. This involves multiple PCIe transactions and will also use host's processor resources to identify the next hardware offload unit to perform the next offloaded operation. Even though some of the hardware offload units can be integrated with the processor, to communicate with them might still require host processor involvement, which is costly. Based on empirical performance data, some embodiments perform offloading for certain data sizes, as offloading provides benefits for these data size as otherwise the cost of submitting the job from CPU would dominate.

Different embodiments use different techniques to allow one hardware offload unit to write to the main memory of the host computer and/or to the memory of another hardware offload unit, and then to provide notification to the second hardware offload unit that it needs to process the newly written data. Some embodiments leverage cache coherency techniques to allow the hardware offload units and the host computer communicate.

In recent years, devices have participated in cache coherency. For instance, AMD opened its cache coherent interface to RDMA adapter vendors who had designed RDMA devices that participate in cache coherence protocol of AMD processor. Similarly, after its acquisition of Altera, Intel opened up its cache-coherent protocol to Altera FPGAs, such that some Altera FPGA can participate in the cache-coherent protocol of Intel processors. And one can implement a networking accelerator or adapter using an Altera FPGA.

In some embodiments, a first hardware offload unit is cache coherent with main memory of the host computer and/or with the memory of a second hardware offload unit. The second hardware offload unit in such a case can snoop (in the cache coherent protocol sense) on the memory location to which the first hardware offload unit writes. This memory location is part of cache-coherent memory space.

It is very efficient for the second hardware offload unit to leverage the cache coherent protocol. The second hardware offload unit will maintain a cache copy of the memory location. As long as no write is done to it, the second hardware offload unit is just watching/reading/evaluating its cache copy. When the first hardware offload unit writes to this memory location, the underlying cache-coherence protocol will invalidate the cache copy in the second hardware offload unit. When the second hardware offload unit next attempts to access this memory location, it encounters a cache miss which will then pick up the value newly written by the first hardware offload unit. This sequence also enables the second hardware offload unit to know that something has changed and it can re-evaluate to decide what actions/processing it needs to take.

In some embodiments, second hardware offload unit utilizes the CXL (computer express link) cache capabilities. CXL (https://www.computeexpresslink.org) is one of the efforts that has been undertaken in recent years to enable cache-coherent interconnect between devices and processors. CXL is built on top of PCIe version 5 (PCIev5). In some embodiments, the host computers have adapter slots that are CXL/PCIev5 slots. Another recent effort to enable cache-cohere interconnect is CCIX (https://www.ccixconsortium.com) and some embodiments use this protocol.

CXL also allows a device to offer memory (CXL.mem). In some embodiments, the second hardware offload unit utilizes CXL.mem to provide memory locations, to which the first hardware offload unit can write. In short, there are many mechanisms/means by which this indication can happen. CXL is getting wide-spread industry adoption, and it greatly expands beyond what traditional PCIe offers.

In some embodiments, the second hardware offload unit that uses CXL has hardware that compares say producer and consumer register values, with the producer register being in the cached memory space snooped by the second hardware offload unit. In some such embodiments, the second hardware offload unit reads the producer register value repeatedly. When the first hardware offload writes to this producer register, the second hardware offload unit retrieves the new value, and its hardware which compares the producer and consumer registers will detect that there is work queued up for it to do.

Conjunctively with the cache coherency protocols, or instead of using cache coherency protocols, some embodiments use Peer-to-Peer transfer capabilities between two PCIe devices to establish the doorbell mechanism between two hardware offload units that are plugged into the PCIe interface of a host computer. Information regarding peer-to-peer transfers can be found at:

https://blog.exxactcorp.com/exploring-the-complexities-of-pcie-connectivity-and-peer-to-peer-communication/

In some embodiments, peer-to-peer communication is limited to DMA only, and does not support MMIO writes from one device to another's MMIO space. The ability to do DMA triggers constructs (e.g., notifications, interrupts, etc.) that notify the second hardware offload unit that it needs to process the data written through the DMA or the data written in the host memory's coherent cache. In other embodiments, peer-to-peer communication between two hardware offload units supports MMIO writes from one peer device to another peer device. Under this approach, the first hardware offload unit MMIO writes to second hardware offload unit's MMIO space, in which consumer/producer pointers reside.

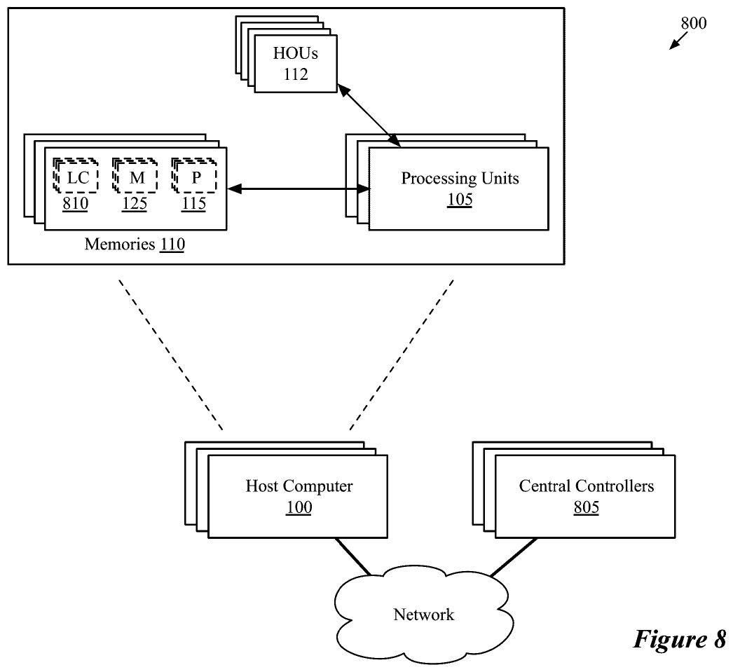

FIG. 8 illustrates a network control system 800 that configures multiple hardware offload units of one or more host computers 100 to perform operations on packets associated with machines executing on these computers and to pass the packets between each other efficiently. The control system 800 includes a set of central controllers 805 executing on one or more servers, and a set of local controllers 810 executing on the host computers 100.

The central and local controllers form a control plane that configures packet processing modules executing on the host computers to perform packet processing operations and/or to provide packets to hardware offload units to perform packet processing operation. The packets in some embodiments are packets sent by machines (e.g., VMs or containers) executing on the host computers and/or are packets received for these machines. Also, in some embodiments, the packet processing modules are modules of the operating system of the host computer, while in other embodiments, these modules are modules of a hypervisor over which virtual machines and/or containers execute on the host computer.

In addition to configuring the packet processing modules to offload some or all of the packet processing onto one or more hardware offload units, the control plane of some embodiments configures one or more hardware offload units of a host computer to perform the packet processing operations on the packets, to identify other hardware offload units that have to perform subsequent operation on the packets, to provide the packets to the subsequent hardware offload units, and to return the packets back to the packet processing modules (executing on the offload unit's host computers) when the packets do not need to be processed subsequently by another hardware offload unit.

In some embodiments, the control plane configures a hardware offload unit to provide the packet to another hardware offload unit by writing to a register of the other hardware offload unit. In other embodiments, the process configures a hardware offload unit to provide the packet to another hardware offload unit by writing to a memory of the host computer, and providing a notification to the second hardware offload unit that it needs to retrieve the packet from the host computer's memory.

In some embodiment, the control plane configures the packet processing modules executing on the host computers to perform packet-processing operations on the packets (1) before providing the packets to any hardware offload units, (2) after the hardware offload units have performed the offload operations, and/or (3) after several hardware offload units (e.g., two or more hardware offload units) have performed some of the offloaded operations but before several other hardware offload units (e.g., two or more hardware offload units) have performed some of the other offloaded operations.

As mentioned above, the packet-processing operations performed by a host's packet-processing modules and/or hardware offload units includes in some embodiments packet forwarding operations and/or middlebox service operations. Also, in some embodiments, the control plane configures these modules and/or hardware offload units to use sets of packet attributes (e.g., packet header values) to identify the packet forwarding and/or middlebox service operation to perform on the packet, and/or to identify the processing modules and/or hardware offload units to process the packets next.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

Some embodiments include electronic components, such as microprocessors, that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms “display” or “displaying” mean displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral or transitory signals.

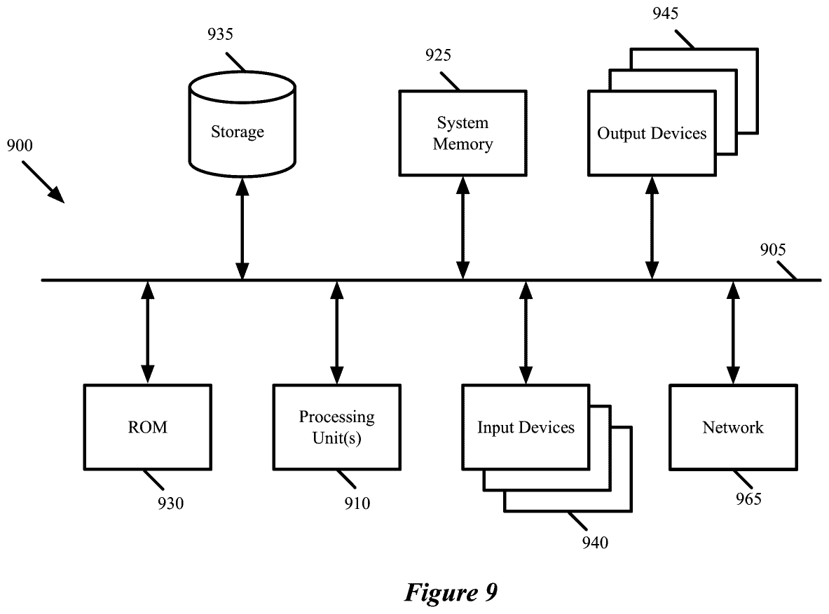

FIG. 9 conceptually illustrates a computer system 900 with which some embodiments of the invention are implemented. The computer system 900 can be used to implement any of the above-described hosts, controllers, and managers. As such, it can be used to execute any of the above described processes. This computer system includes various types of non-transitory machine readable media and interfaces for various other types of machine readable media. Computer system 900 includes a bus 905, processing unit(s) 910, a system memory 925, a read-only memory 930, a permanent storage device 935, input devices 940, and output devices 945.

The bus 905 collectively represents all system, peripheral, and chipset buses that communicatively connect the numerous internal devices of the computer system 900. For instance, the bus 905 communicatively connects the processing unit(s) 910 with the read-only memory 930, the system memory 925, and the permanent storage device 935.

From these various memory units, the processing unit(s) 910 retrieve instructions to execute and data to process in order to execute the processes of the invention. The processing unit(s) may be a single processor or a multi-core processor in different embodiments. The read-only-memory (ROM) 930 stores static data and instructions that are needed by the processing unit(s) 910 and other modules of the computer system. The permanent storage device 935, on the other hand, is a read-and-write memory device. This device is a non-volatile memory unit that stores instructions and data even when the computer system 900 is off. Some embodiments of the invention use a mass-storage device (such as a magnetic or optical disk and its corresponding disk drive) as the permanent storage device 935.

Other embodiments use a removable storage device (such as a floppy disk, flash drive, etc.) as the permanent storage device. Like the permanent storage device 935, the system memory 925 is a read-and-write memory device. However, unlike storage device 935, the system memory is a volatile read-and-write memory, such as random access memory. The system memory stores some of the instructions and data that the processor needs at runtime. In some embodiments, the invention's processes are stored in the system memory 925, the permanent storage device 935, and/or the read-only memory 930. From these various memory units, the processing unit(s) 910 retrieve instructions to execute and data to process in order to execute the processes of some embodiments.

The bus 905 also connects to the input and output devices 940 and 945. The input devices enable the user to communicate information and select requests to the computer system. The input devices 940 include alphanumeric keyboards and pointing devices (also called “cursor control devices”). The output devices 945 display images generated by the computer system. The output devices include printers and display devices, such as cathode ray tubes (CRT) or liquid crystal displays (LCD). Some embodiments include devices such as touchscreens that function as both input and output devices.

Finally, as shown in FIG. 9, bus 905 also couples computer system 900 to a network 965 through a network adapter (not shown). In this manner, the computer can be a part of a network of computers (such as a local area network (“LAN”), a wide area network (“WAN”), or an Intranet), or a network of networks (such as the Internet). Any or all components of computer system 900 may be used in conjunction with the invention.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

What is claimed is:

1. A method comprising:
executing a plurality of machines on a host computer, the host computer comprising a plurality of hardware offload units and one or more processing units, the hardware offload unit comprising a first hardware offload unit and a second hardware offload unit, the plurality of machines comprising a first machine;
identifying the first hardware offload unit to perform a first operation on a packet associated with the first machine;
configuring the first hardware offload unit to process a first action stage without involving the one or more processing units;
performing the first operation using the first hardware offload unit on the packet; and
identifying, by the first hardware offload unit, the second hardware offload unit to perform a second operation on the packet.

2. The method of claim 1, further comprising providing the packet to the second hardware offload unit.

3. The method of claim 1, further comprising configuring the second hardware offload unit to perform the second operation.

4. The method of claim 1, wherein the configuring the first hardware offload unit comprises configuring the first hardware offload unit to write to a register of the second hardware offload unit.

5. The method of claim 1, wherein the configuring the first hardware offload unit comprises configuring the first hardware offload unit to write to a memory of the host computer to cause a notification to be provided to the second hardware offload unit without using the one or more processing units.

6. The method of claim 1, further comprising providing the packet to a third hardware offload unit by the second hardware offload unit.

7. The method of claim 1, wherein the first operation is associated with a hypervisor executing on the host computer.

8. The method of claim 1, wherein the first machine comprises a virtual machine.

9. The method of claim 1, wherein the first machine comprises a container or a Pod.

10. The method of claim 1, wherein the first operation comprises a packet forwarding operation or a packet middlebox service operation.

11. The method of claim 1, further comprising matching attributes of the packet to a match record, the first operation being specified by a first action record associated with the match record.

12. The method of claim 11, wherein the match record comprises a next action record identifying the second hardware offload unit.

13. The method of claim 1, wherein the first operation comprises a plurality of sub-operations specified by action records.

14. The method of claim 1, wherein the first hardware offload unit comprises a plurality of action stages in a packet-processing pipeline, the plurality of the action stages comprising the first action stage.

15. A host computer system comprising:
one or more processing units, the one or more processing units comprising a first processing unit;
a memory;
a plurality of hardware offload units, the plurality of hardware offload units comprising a first offload unit and a second hardware offload unit;
wherein the first processing unit is configured to:
execute a plurality of machines, the plurality of machines comprising a first machine;
identify the first hardware offload unit to perform a first operation on a packet associated with the first machine;
configure the first hardware offload unit to process an action stage without involving the one or more processing units;
cause the first hardware offload unit to perform the first operation on the packet; and
configure the second hardware offload unit to perform a second operation on the packet based on an identification of the second hardware offload unit by the first hardware offload unit.

16. The host computer system of claim 15, wherein the first machine comprises a virtual machine or a container.

17. The host computer system of claim 15, wherein first hardware offload unit is configured to write to a register of the second hardware offload unit.

18. The host computer system of claim 15, wherein first hardware offload unit is configured to write to the memory.

19. The host computer system of claim 17, wherein the writing to the memory causes a notification to be provide to the second hardware offload unit without using the one or more processing units.

20. The host computer system of claim 15, wherein the plurality of hardware offload units comprises a FPGA, a GPU, a smart NIC.
